(19) United States
(12) Patent Application Publication
(10) Pub. No.: US 2003/0187112 A1
(43) Pub. Date: Oct. 2, 2003

(54) Oligomer-type flame retardant compound and flame-retardant resin composition comprising same

(75) Inventors: Sang-Ha Kim, Ulsan-city (KR); Duk-Suk Jung, Ulsan-city (KR); Dong-Kyung Park, Pusan-city (KR); Jong-Ho Park, Seoul (KR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Songwon Industrial Co., Ltd., Ulsan-city (KR)

(21) Appl. No.: 10/278,306

(22) Filed: Oct. 23, 2002

Related U.S. Application Data
(63) Continuation of application No. PCT/KR02/00465, filed on Mar. 19, 2002.

(51) Int. Cl. C08K 5/52; C07F 9/02; C08K 5/49

(52) U.S. Cl. 524/127; 524/145; 558/162

(57) ABSTRACT

Disclosed is a flame-retardant composition including an oligomer-type flame-retardant compound represented by formula 1, which gives good flame retardation, heat-resistance, hydrolysis-resistance and fluidity characteristics to resin.

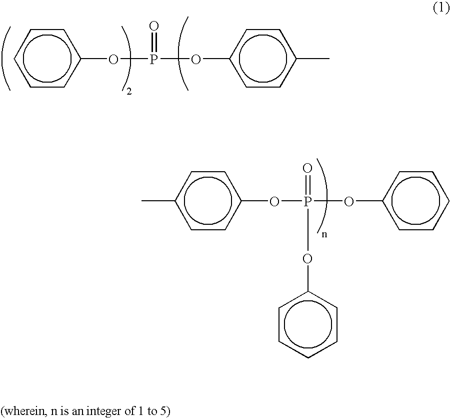

(wherein, n is an integer of 1 to 5)

### BACKGROUND OF THE INVENTION

(a) Cross Reference to Related Applications

This application is a continuing application of International Application No. PCT/KR02/00465, filed Mar. 19, 2002, which is hereby incorporated herein in its entirety by reference.

(b) Field of the Invention

The present invention relates to an oligomer-type phosphate flame-retardant compound and a flame-retardant resin composition comprising the same, and more particularly, to an oligomer-type flame-retardant compound which gives good flame retardation, heat-resistance, and hydrolysis-resistance to resin, has low volatility, and does not contaminate moldings, and a flame-retardant resin composition comprising the same.

(c) Description of the Related Art

As flame-retardants for resins, inorganic-type, organic halogen-type, and organic phosphor-type flame-retardant compounds are widely known. Because of poor flame-retardation of the inorganic-type flame-retardant compound, a substantial amount thereof is required, resulting in the deterioration of the inherent properties of the resin. And even though the organic halogen-type flame-retardant compound has good flame-retardation, it has a drawback in that the compound thermally decomposes to generate hydrogen halide. The hydrogen halide causes contamination to moldings and generates human-harmful gas when the forming material is combusted. Therefore, the organic phosphor-type flame-retardant compound has recently attention.

The exemplary of the organic phosphor-type flame-retardant compounds may be triarylphosphoric esters such as triphenylphosphate, tricresylphosphate, and trixylenylphosphate. However, the low boiling point of these compounds because of their low molecular weight causes them to be easily volatilized, thereby contaminating moldings and providing a bad external appearance of the resulting forming material.

In order to solve such problems, phosphoric ester with a low volatility is disclosed in U.S. Pat. No. 2,520,090, European Patent Laid-Open Nos. 129824, 129825, and 135796 and Japanese Patent Laid-Open No. Sho. 54-32818.

In particular, Japanese Patent No. Hei. 7-258539 discloses that a phosphoric ester oligomer represented by the following formula A, which is cross-linked with a moiety of 2,2-bis(4-hydroxyphenyl)propane (hereinafter, “bisphenol A”), and has heat-resistance and hydrolysis-resistance as good as one cross-linked by a moiety of a mono-ring phenol such as resorcinol.

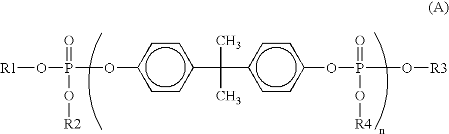

(wherein n is an integer of 0 to 10, R1 to R4 groups are independently phenyl, tolyl or xylyl, and if n is equal to or more than 2, at least two R4 groups are the same or different)

However, when the oligomer represented by formula A is applied to engineering plastics of which a molding process is performed at a high temperature, such as a polycarbonate resin, the side reaction that occurs (breakage of backbone of bisphenol A) generates monomers such as triphenylphosphate or isoprophenylphosphate which causes contamination of the moldings.

Furthermore, isoprophenyldiphenylphosphate has shortcomings in that this unsaturated group provides poor light-resistance to the resin as well as the contamination.

Japanese Patent Laid-Open No. Hei. 5-1079 teaches a high-purity aromatic diphosphate exhibiting good heat-resistance in which moieties at 2- and 6-positions are substituted with alkyl group-containing monohydric phenol, and a method of preparing the same. However, the rigid structure at 2- and 6-position decreases compatibility with the resin and deteriorates forming processing.

The heat-resistance of the flame-retardant compound is derived from a dihydric phenol rather than a monohydric phenol, resorcinol has shortcomings such as poor heat-resistance and hydrolysis-resistance, and bisphenol A of formula A with relatively good heat-resistance has drawbacks such as the breakage of the structure.

### SUMMARY OF THE INVENTION

An object of the present invention is to provide an oligomer-type flame retardant compound exhibiting good flame-retardation, heat-resistance, hydrolysis-resistance, and compatibility with resin.

Another object of the present invention is to provide an oligomer-type flame retardant compound without a halogen, and which causes no contamination and corrosion of moldings

Still another object of the present invention is to provide a flame-retardant resin composition including the flame-retardant compound.

### DETAILED DESCRIPTION OF THE INVENTION

The present invention relates to an oligomer-type phosphoric ester flame-retardant compound without halogen, represented by formula 1.

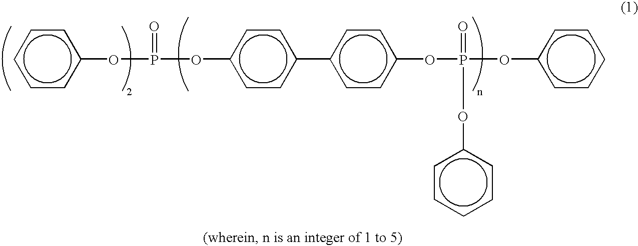

(wherein n is an integer of 1 to 5)

The 4,4′-biphenol structure, dihydric phenol structure, in the phosphoric ester flame-retardant compound provides excellent heat-resistance and flame-retardation.

In addition, an unsubstituted monohydric phenol moiety at a terminal of the phosphoric ester flame-retardant compound provides superior heat-resistance, hydrolysis-resistance and compatibility with resin.

The phosphoric ester flame-retardant compound represented by formula 1 has a melting point of 70 to 89° C.

A flame-retardant resin composition including the phosphoric ester flame-retardant compound includes a rubber-modified styrene-based polymer or unmodified styrene-based polymer as a resin, and may further include an aromatic polycarbonate.

The present invention will be illustrated in more detail.

The oligomer-type phosphoric ester represented by formula 1, used as a flame-retardant compound in the present invention may be prepared by the conventional procedure disclosed in U.S. Pat. No. 2,520,090, and Japanese Patent Laid-Open Nos. Sho. 62-25706 and 63-227632.

Phosphorus oxychloride, a biphenol, and a phenol are mixed in the presence of a Lewis acid such as magnesium chloride or aluminum chloride to prepare a crude phosphoric ester. The obtained crude phosphoric ester is washed and purified to remove the chloride and catalyst followed by dehydrating and drying.

Alternatively, the oligomer-type phosphoric ester represented by formula 1 may be prepared by the following procedure.

(1) A biphenol reacts with phosphorous oxychloride in the presence of a Lewis acid such as magnesium chloride or aluminum chloride to prepare crude phosphoric ester. The crude phosphoric ester is purified by the general purification process. For example, unreacted phosphorous oxychloride is removed from the crude phosphoric ester, and the resulting material reacts with a phenol in an organic solvent such as an aromatic solvent substituted with an alkyl group, e.g. toluene or xylene, or a hydrocarbon solvent, e.g. heptane or hexane, thereby obtaining a flame-retardant compound of formula 1. At this time, the amount of phosphorous oxychloride is 2.1 to 10 M, and that of phenol is 4 M based on 1 M of biphenol.

(2) Diphenylphosphoro chloridate reacts with a biphenol in the presence of a catalyst and a solvent to prepare a crude phosphoric ester. The catalyst acts to remove a side product, hydrochloric acid, and it may be a low alkyl amine such as triethylamine, trimethylamine, tripropylamine, or tributylamine, or tertiary amine such as pyridine diazabicyclooctane. The solvent may be toluene, benzene, or xylene. At this time, the amount of diphenylphosphoro chloridate is 2 M based on 1 M of biphenol. The crude phosphoric ester is purified by the general purification process. For example, the crude phosphoric ester is washed with water and dried to prepare a flame-retardant compound of formula 1.

By the above procedure, a mixture of compounds of formula 1 in which n is 1 to 5 as an oligomer-type phosphoric ester is obtained. The mixture may be used as a flame-retardant compound, or a pure compound which is obtained by purifying the mixture may also be used as a flame-retardant compound. Alternatively, one pure compound in which n is one of 1 to 5 is mixed with another pure compound to use as a flame-retardant compound. If the mixture is used, it is preferred to use the mixture including a compound in which n is 1 or 2 as a main component, and a trace amount of the impurity triphenylphosphate (n is 0 in formula 1), may be included in the mixture. However, if the amount of triphenylphosphate increases, the boiling point decreases and it is easily volatilized, thereby contaminating the molding, and thus, as the amount of triphenylphosphate decreases, a flame-retardant compound with good properties is obtained.

A flame-retardant resin composition of the present invention includes the flame-retardant compound and a rubber-modified or unmodified styrene-based polymer as a resin. Furthermore, the composition further includes an aromatic polycarbonate as a thermoplastic resin. If the aromatic polycarbonate is used, the styrene polymer to aromatic polycarbonate ratio is preferably 5 to 95:95 to 5.

The rubber-modified or unmodified styrene-based polymer may be a styrene-homopolymer, a styrene-copolymer or a styrene-graft copolymer. The styrene-homopolymer is prepared by polymerizing an aromatic vinyl compound, the styrene-copolymer is prepared by polymerizing an aromatic vinyl compound and at least one vinyl monomer which is capable of copolymerizing the aromatic vinyl compound, and the styrene-graft copolymer is prepared by graft-copolymerizing the aromatic vinyl compound, the vinyl monomer, and a diene compound.

The aromatic vinyl compound may be styrene, o-methyl styrene, p-methyl styrene, m-methyl styrene, α-methyl styrene, vinyl toluene, a halogen-substituted styrene such as styrene chloride, or an alkyl ring-substituted styrene such as cyclohexyl styrene.

The vinyl monomer which is capable of copolymerizing the aromatic vinyl compound may be a cyanide vinyl compound, a C₁ to C₈ alkylacrylate, a C₁ to C₈ alkylmethacrylate, maleic acid dialkylester, or an N-substituted maleimide. The cyanide vinyl compound may be acrylonitrile or methacrylonitrile. The C₁ to C₈ alkylacrylate may be methylacrylate, ethylacrylate, n-butylacrylate, iso-butylacrylate, t-butylacrylate or 2-ethylhexylacrylate. The C₁ to C₈ alkylmethacrylate may be methylmethacrylate, ethylmethacrylate, n-butylmethacrylate, iso-butylmethacrylate, t-butylmethacrylate or 2-ethylhexylmethacrylate. The maleic acid dialkylester may be maleic acid di n-amylester, maleic acid diiso-butylester, maleic acid dimethylester, maleic acid di n-propylester, maleic acid dioctylester, maleic acid dinonylester, or maleic acid anhydride. The N-substituted maleimide may be maleimide, N-methyl maleimide, N-ethyl maleimide, N-phenyl maleimide, or N-cyclohexyl maleimide.

The diene compound may be butadiene, dicyclopentadiene, isoprene, chloroprene, phenylpropadiene, cyclopentadiene, 1,5-norbonadiene, 1,3-cyclohexadiene, 1,4-cyclohexadiene, 1,5-cyclohexadiene, or 1,3-cyclooctadiene.

The aromatic polycarbonate used in the present invention is obtained from the reaction between at least a dihydric phenol, phosgene, and a diester carbonate.

The dihydric phenol compound may be dihydroxydiarylsulfones such as 2,2-bis(4-hydroxybiphenyl)propane (i.e. Bisphenol A), bis(4-hydroxyphenyl)methane, bis(4-hydroxyphenyl)phenylmethane, bis(4-hydroxyphenyl)naphtylmethane, bis(4-hydroxyphenyl)-(4-isopropylphenyl)methane, bis(3,5-dimethyl-4-hydroxyphenyl)methane, 1,1-bis(4-hydroxyphenyl)ethane, 1-naphtyl-1,1-bis(4-hydroxyphenyl)ethane, 1-phenyl-1,1-bis(4-hydroxyphenyl)ethane, 1,2-bis(4-hydroxyphenyl)ethane, 2-methyl-1,1-bis(4-hydroxyphenyl)propane, 2,2-bis(3,5-dimethyl-4-hydroxyphenyl)propane, 1-ethyl-1,1-bis(4-hydroxyphenyl)propane, 2,2-bis(3-methyl-4-hydroxyphenyl)propane, 1,1-bis(4-hydroxyphenyl)butane, 2,2-bis(4-hydroxyphenyl)butane, 1,4-bis(4-hydroxyphenyl)butane, 2,2-bis(4-hydroxypheyl)pentane, 4-methyl-2,2-bis(4-hydroxyphenyl)pentane, 2,2-bis(4-hydroxyphenyl)hexane, 4,4-bis(4-hydroxyphenyl)heptane, 2,2-bis(4-hydroxyphenyl)nonane, or 1,10-bis(4-hydroxyphenyl)decane; dihydroxydiarylcycloalkanes such as 1,1-bis(4-hydroxyphenyl)-3,3,5-trimethylcyclohexane, 1,1-bis(4-hydroxyphenyl)cyclohexane, 1,1-bis(4-hydroxyphenyl)cyclodecane; dihydroxydiarylsulfones such as bis(4-hydroxyphenyl)sulfone, bis(3,5-dimethyl-4-hydroxyphenyl)sulfone; dihydroxydiarylethers such as bis(4-hydroxyphenyl)ether, bis(3,5-dimethyl-4-hydroxyphenyl)ether; dihyroxydiarylketones such as 4,4′-dihydroxybenzophenone or 3,3′-5,5′-tetramethyl-4,4′-dihydroxybenzophenone; dihydroxydiarylsulfades (sulfates) such as bis(4-hydroxyphenyl)sulfade (sulfate), bis(3-methyl-4-hydroxyphenyl)sulfade (sulfate), bis(3,5-dimethyl-4-hydroxyphenyl)sulfade (sulfate); dihydroxydiarylsulfoxides such as bis(4-hydroxyphenyl)sulfoxide; dihydroxyphenyls such as 4,4′-dihydroxybiphenyl; or didhyroxyarylfluorenes such as 9,9-bis(4-hydroxyphenyl)fluorene. Preferred is bisphenol A. Furthermore, dihydroxybenzenes such as hydroxynone, resorcinol, and methylhydroxynone, or dihydroxynaphthalenes such as 1,5-hydroxynaphthalene may be used. One or a mixture of the dihydric phenol may be used.

The diester carbonate compound may be diarylcarbonates such as diphenylcarbonate, or dialkylcarbonates such as dimethylcarbonate, or diethylcarbonate.

An example of the thermoplastic resin may be polyphenylene ether-based resin (e.g. modified polyphenylether (modified PPE)), polyethylene, polypropylene, polystyrene, impact-resistant polystyrene, ACS resin, AS resin, ABS resin, polycarbonate, polyamide, polyimide, polymethylmethacrylate, polyphenylene sulfate, polyether ether ketone, polyether sulfone, polysulfone, polyarylate, polyethyleneterephthalate (PET), polybutylene terephthalate (PBT), polyethylene naphthalate (PEN), polyacetal, polyetherketones, polyethernitrile, polythio ethersulforane, polybenzimidazole, polycarboxyl imide, liquid crystalline polymer and polymer blend thereof, and polymer alloy (e.g. PC/ABS polymer-alloy).

Preferred are an acrylonitrile-butadiene-styrene copolymer (ABS) resin or a mixture of aromatic polycarbonate PC/ABS resins.

The amount of the flame-retardant compound added to the flame-retardant resin composition of the present invention can be controlled according to the types of resin and the required flame-retardation, but the amount is preferably 1 to 40 parts by weight based on 100 parts by weight of the resin, more preferably 5 to 40 parts by weight, and most preferably 10 to 30 parts by weight.

If the amount of the flame-retardant compound is less than 1 part by weight, sufficient flame-retardation is not obtained. Whereas, if the amount of the flame-retardant compound is more that 40 parts by weight, the inherent performance of the resin deteriorates.

The flame-retardant resin composition of the present invention may further include a monomer or oligomer-type organic phosphoric flame-retardant compound, or a stable red phosphorous or silicone-based flame-retardant compound in addition to the compound of formula 1. The monomer-type organic phosphoric flame-retardant compound increases fluidity and improves volatilization. Moreover, the composition may further include magnesium hydroxide, aluminum hydroxide, phosphoric melamine, melaminecyanurate, or polyphosphoric ammonium melamine.

The example of the monomer-type organic phosphoric flame-retardant compound may be triphenylphosphate, tricresylphosphate, cresyldiphenylphosphate, trixylylphosphate, dicresyl-2,6-diphenylphosphate, or tris(2,6-dimethylphenyl)phosphate; and the example of the oligomer-type organic phosphoric flame-retardant compound may be resorcinolbis(diphenylphosphate), bisphenol A bis(diphenylphosphate), or resorcinolbis[(bis-2,6-dimethylphenyl)phosphate.

The example of the stable red phosphorous may be a thermosetting resin-coated red phosphorous, an olefin-coated red phosphorous, titan oxide coated red phosphorous or a condensed material of titan aluminum coated red phosphorous; and the example of the silicone-based flame-retardant compound may be silicone resin, silicone glass, silicone rubber, or silicone oil.

Alternatively, the flame-retardant resin composition may also include various general additives within a range at which the physical properties of the resin are not deteriorated, if necessary. These additives may be one or at least two compounds. The example of the additives may be a flame-retardant aid, an agent for preventing dripping, a filler, an antioxidant (stabilizer), an antistatic agent, a softening agent, a pigment, an ultraviolet ray absorbent (photo stabilizer), and a reinforcement agent.

The flame-retardant aid may be graphite, active carbon, boric acid salts, frit, or carbon powder such as a carbon plate prepared by an oil-furnace, gas-furnace, channel, or acetylene technique.

The agent for preventing dripping is desirably a fluorinated-based resin. The examples thereof are polytetrafluoroethylene, a polytetrafluoroethylene-polyhexafluoropropylene copolymer, a polytetrafluoroethylene-polyfluoroalkylvinylethylene copolymer, a polytetrafluoroethylene-ethylene copolymer, or polytrifluoromonochloroethylene. The fluorinated-based resins may be emulsions, suspensions, microfabrics, powders, or particles. The dripping-preventing agent is one or at least two compounds.

The filler may be a power-type, a particle-type or a plate-type inorganic filler such as glass fiber, carbon fiber, ceramic fiber, mica, silica, talc, potassium carbonate, alumina, glass bead, glass balloon type filler, glass flake, or an organic filler such as wooden powder. The filler may be one or at least two compounds.

The antioxidant (stabilizer) may be phosphorous such as pentaerythritoldiphosphite, hindered phenol derivatives, phenols such as di-t-butylhydroxytoluene, (e.g. octadecyl-3,5-di-tertiarybutyl-4-hydroxycinnamate), amines such as diphenylamine, or a sulfone-based compound such as dilauryl-dithiopropionate, and disteary-dithiopropionate; and the antistatic agent may be a cation activator or a nonionic activator. The softening agent may be aliphatic derivatives and a high-boiling point wax, and the pigment may be titanium oxide or phthalocyanines. The ultra-violet absorbent may be a benzophenone-based compound, a salicylate such as a dialkyl-phenylsalicylate, benzotriazole-based compound, or an acrylonitrile-based compound; and the reinforcement agent may be glass fiber, metal fiber, or whisker.

In flame-retardant resin composition preparation, the order of mixing and the mixing procedure are limited. One preparation will be illustrated. The oligomer-type phosphoric ester of formula 1, a thermoplastic resin, and if necessary various additives are mixed by the conventional techniques, and the mixture is melt-mixed to prepare a flame-retardant resin composition. The mixing and melt-mixing steps employ one or a combination of a single extruder, a vent-attached two-axis extruder, and a two-axis extruder, a hensel mixer, a Bumbury's mixer, a kneader mixer, or a roller.

The obtained resin composition is molded by general procedures such as injection molding, or extrusion, to fabricate predetermined shapes, e.g. plate, sheet, or film.

The following examples further illustrate the present invention, but the invention is not limited by these examples.

In Examples and Comparative Examples, the following compositions were used.

(1) Resin composition

PC/ABS resin; Kaneda Corporation No. ALPHALOY MPC4601

ABS resin; dicell polymer, Co. Ltd. No CEVIAN-V-500

Agent for preventing dripping: Polytetrafluoroethylene (Mitzui Dupont Fluorochemical Co. Ltd., Trade Mark: PTFE6-J)

### EXAMPLE 1

Synthesis of an oligomer-type phosphoric ester compound

186.2 g of 4,4′-biphenol (1 M), 767.5 g of phosphorous oxychloride (5.0M) and 1.5 g of anhydrous magnesium chloride were charged into a 2L four-neck flask with a stirrer, a refluxing tube and a thermometer. The resulting mixture was heated to 100° C. for 2 hours while shaking under a nitrogen atmosphere, and then shaken at 100° C. for 1 hour. When the mixture reached 100° C., the pressure was reduced to about 2.7 kPa to remove the produced hydrogen chloride gas and to recover excess phosphorous oxychloride. The reacted mixture was cooled to 80° C., and 367.0 g of phenol (3.9M) which corresponded to the remaining chloride %, and 30 g of toluene, were added to the resulting mixture. The obtained material was heated to 150° C. over 2 hours while shaking under a nitrogen atmosphere, and the removal of hydrochloric acid from the resulting material was performed at the same temperature (150° C.) under reduced pressure (about 20 kPa) for 2 hours. After the completion of the removal, the reacted material was cooled to 100° C. The cooled material was adjusted to ambient pressure with nitrogen, and 100 g of toluene were added to the material. The product was sequentially washed with 3.5% hydrochloric acid and 1.7% sodium carbonate, and finally washed with water. Thereafter, the washed material was vapor-evaporated at 120° C. under reduced pressure (about 2.7 kPa) to remove low boiling point components, followed by cooling and crystallizing, thereby obtaining 623 g of a product 623 g (96% of crude yield).

Melting point: 80° C.

The composition of the product was determined by liquid chromatography.

| Composition: | | |
|---|---|---|
| In Formula 1, | n is 1 | 84.5% |
| | n is 2 | 11.5% |
| | n is 3 | 3.5% |

| | |
|---|---|
| Triphenylphosphate | 0.5% |

The content of phosphorous in the product was measured.

The content of phosphorous: 9.5%

### EXAMPLE 2

Synthesis of an oligomer-type phosphoric ester compound

186.2 g of 4,4′-biphenol (1 M), 222 g of triethylamine (2M) and 900 g of toluene were charged into a reactor as used in Example 1. 537 g of diphenylphosphorochloridate (2M) was added to the reactor at 30 to 40° C. over 1.5 hours, and the temperature was kept at 40 to 55° C. for 1 hour. The resulting material was washed twice with 250 g of hot water at 60 to 70° C., washed with 250 g of a 3.5% aqueous solution of chloride, washed with 250 g of 5% NaOH, and washed twice with 250 g of hot water to remove the produced triethylamine hydrochloric acid salt. The washed material was vapor-evaporated at 120° C. under reduced pressure (about 2.7 kPa) to remove components with a low boiling point, followed by cooling and crystallizing, thereby obtaining 648 g of a product (99.7% of crude yield).

Melting point; 88° C.

The composition of the resulting product was determined by liquid chromatography.

| Composition; | | |
|---|---|---|
| In Formula 1, | n is 1 | 98.5% |
| | n is 2 | 1.0% |

| | |
|---|---|
| Triphenylphosphate (in Formula 1, n is 0) | 0.5% |

The content of phosphorous in the resulting product was measured.

The content of phosphorous: 9.54%

### EXAMPLES 3 AND 4

The amount of flame-retardant compound disclosed in Table 1 according to Examples 1 and 2, and 0.4 parts by weight of the agent for preventing dripping based on 100 parts by weight of PC/ABS resin-alloy were added to the resin-alloy, and mixed with a Hensel type mixer. The mixture was melt-mixed with a vent-attached two-axis extruder to prepare a flame-retardant resin composition paste. The amount of the flame-retardant compound was controlled to V-O, the vertical firing (UL) test result.

### COMPARATIVE EXAMPLES 1 TO 4

A flame-retardant resin composition was prepared by the same procedure as in Example 1, except that a flame-retardant compound used the following component, and the amount of the flame-retardant compound was changed to the amount of Table 1.

The flame-retardant compound of Comparative Example 1: triphenylphosphate (Disflamoll(R)TP Bayer AG)

The flame-retardant compound of Comparative Example 2: Phenol`resorcinol polyphosphate (Ryroflex(R)RDP AkzoNobel)

The flame-retardant compound of Comparative Example 3: Phenol`bisphenol-A polyphosphate (ADK-STAB FP-600 Asahidenka)

The flame-retardant compound of Comparative Example 4: Resorcinol bis(di-2,6-dimethylphenylphosphate)(ADK-STAB FP-500 Asahidenka)

Measurement of properties

The pastes according to Examples 3 and 4 and Comparative Examples 1 to 4 were molded with an injection-molding device to fabricate a sample for a flame-retardant (vertical firing) test and a sample for a mechanical test. The physical properties of the samples were measured by the following test procedure. The results, the mixed components in the resin composition, and the mixing ratio are presented in Tables 1 and 2.

(1) Vertical firing (UL) Test

Test procedure: based on UL-94 (5 Average firing time)

Sample: Thickness 1.6 mm

Evaluation: According to unit, lank V-0, V-1, and V-2

(2) Weight loss by heating

Pellets obtained from the resins according to Examples 3 and 4, and Comparative Examples 1 to 4 (Diameter: about 2 mm; length: about 3 mm; weight: about 10 mg) were heated to 300° C. at the increasing rate of 20° C./minute by using an open cell and thermal analyzer such as TG-DTA under a nitrogen atmosphere, and percent of the decreased weight (weight %) was measured.

(3) Fluidity test

The resin compositions according to Examples 3 to 4, and Comparative Examples 1 to 4 were dried the predetermined condition to measure MFR (melt mass-flow rate).

Sample: resin pellet (diameter: about 2 mm, length: about 3 mm)

Drying condition: 95° C., 3 hours

Measuring method: based on JIS K-7210

Measuring condition: PC/ABS: 230° C., load 5.0 kg

ABS: 200° C., load 5.0 kg

Unit: g/10 minutes

(4) Hydrolysis-resistance

75 of each flame-retardant compounds according to Examples 3 and 4 and Comparative Examples 1 to 4 (before test, all acidity was equal to or less than 0.1), and 25 g of distilled water were added to a bottle, and the bottle was tightly sealed with Teflon tape followed by heating at 95° C. for 48 hours in an incubator. After the completion of hydrolysis, a water layer was separated and the separated water layer was titrated with a N/10 NaOH solution to measure total acidic value in the water layer.

(5) Flaming test

While the resin composition pastes according to Examples 3 and 4, and Comparative Examples 1 to 4 were molded, the flaming occurrence was observed by eye. The symbol “O” refers to no occurrence of flaming and the symbol “X” refers to occurrence of flaming.

TABLE 1

| | | | | Comparative | Comparative | Comparative | Comparative |
|---|---|---|---|---|---|---|---|
| | | Example 3 | Example 4 | Example 1 | Example 2 | Example 3 | Example 4 |
| Composition | Resin (PC/ABS) | 100 | 100 | 100 | 100 | 100 | 100 |
| | Flame-retardant compound | 12 | 12 | 14 | 12 | 18 | 19 |
| | Agent for preventing dripping | 0.4 | 0 4 | 0 4 | 0 4 | 0 4 | 0 4 |
| Physical properties | Bending strength (Kgf/cm²) | 910 | 740 | 850 | 890 | 890 | 890 |
| | Bending (100 kgf/cm²) | 276 | 270 | 233 | 237 | 252 | 250 |
| | HDT (18.6 kgf/cm²° C.) | 91 | 90 | 76 | 86 | 84 | 85 |
| | MFR (230° C./5 kg(g/10 min.)) | 15 | 15 | 19 | 11 | 17 | 15 |
| | Weight loss by heating (wt %) | 0.5 | 0 5 | 5.0 | 1.2 | 0.9 | 0 5 |
| | Flame | ◯ | ◯ | X | ◯ | ◯ | ◯ |
| | Hydrolysis-resistance | 5 | 5 | 5 | 16000 | 25 | 25 |

As shown in Table 1, the resin compositions according to Examples 3 and 4 exhibit good flame-retardation, bending strength, bending elasticity, HDT, and low volatilization (low weight loss by heating) compared to those of Comparative Examples 1 to 4.

### EXAMPLES 5 TO 6

A flame-retardant resin composition paste was prepared by the same procedure as in Example 3, except that an ABS resin was used, and the amount of the flame-retardant compound was 20 parts by weight.

### COMPARATIVE EXAMPLES 5 to 8

A flame-retardant resin composition paste was prepared by the same procedure as in Comparative Example 1, except that an ABS resin was used, and the amount of the flame-retardant compound was 20 parts by weight.

Using the resin composition paste according to Examples 5 and 6, and Comparative Examples 5 to 8, samples were fabricated by the same procedure as described above. The physical properties of the samples were measured with the same technique. These results, the composition, and ratio are presented in Table 2. The flame-retardant level was equal to or less than V-2.

TABLE 2

| | | | | Comparative | Comparative | Comparative | Comparative |
|---|---|---|---|---|---|---|---|
| | | Example 5 | Example 6 | Example 5 | Example 6 | Example 7 | Example 8 |
| Composition | Resin (PC/ABS) | 100 | 100 | 100 | 100 | 100 | 100 |
| | Flame-retardant compound | 20 | 20 | 20 | 20 | 20 | 20 |
| Physical properties | Agent for preventing dripping | 0 4 | 0.4 | 0 4 | 0 4 | 0.4 | 0.4 |
| | Bending strength (Kgf/cm²) | 630 | 620 | 510 | 560 | 590 | 600 |
| | Bending (100 kgf/cm²) | 265 | 260 | 234 | 237 | 255 | 252 |
| | HDT (16.5 kgf/cm²° C.) | 73 | 71 | 54 | 64 | 67 | 67 |
| | MFR (230° C./5 kg(g/10 min.)) | 23 | 23 | 28 | 20 | 19 | 18 |
| | Weight loss by heating (wt %) | 0.7 | 0 7 | 7 5 | 2.5 | 1 2 | 0 9 |
| | Flame | ◯ | ◯ | X | X | ◯ | ◯ |

As shown in Table 2, the resin compositions according to Examples 5 and 6 exhibit good flame-retardation, heat-resistance, hydrolysis-resistance, compatibility with resin, and physical properties (mechanical property such as bending strength, high HDT, low weight loss, good flame-retardation and high MFR) even though the composition used the ABS resin.

The resin composition according to Comparative Examples 5 and 6 in which the flame-retardant compound has relatively good compatibility with resin exhibit low HDT, high weight loss, and low flame-retardation, and those according to Comparative Examples 7 and 8 in which the flame-retardant compound has good heat-resistance exhibit bad physical properties (HDT, weight loss) and low MFR.

The flame-retardant compound of the present invention gives good flame-retardation, heat-resistance, hydrolysis-resistance and fluidity to resin at a small amount, and it exhibits low volatilization and does not contaminate moldings. The flame-retardant compound has good compatibility with resin, does not deteriorate its inherent performance, provides good resin composition, and is a usable non-halogen flame-retardant compound.

What is claimed is:

1. An oligomer-type flame retardant compound represented by formula 1: 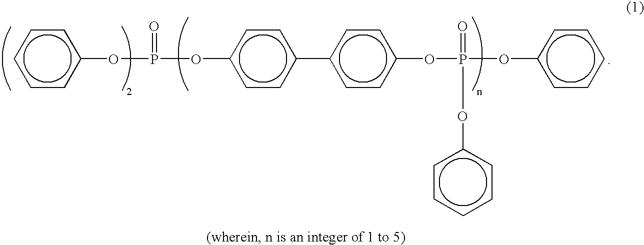
(wherein, n is an integer of 1 to 5).

2. A flame-retardant resin composition comprising:
a resin comprising a rubber-modified or unmodified styrene-based polymer; and
a phosphoric ester flame-retardant compound represented by formula 1. 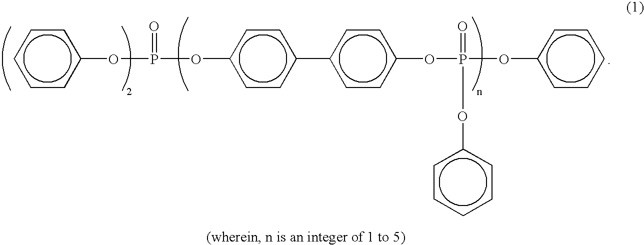
(wherein, n is an integer of 1 to 5).

3. The flame-retardant resin composition of claim 2 wherein the flame-retardant resin composition further comprises an aromatic polycarbonate resin.

4. The flame-retardant resin composition of claim 2 wherein the flame-retardant resin composition further comprises an aromatic polycarbonate resin, and the weight ratio of the styrene-based polymer and the aromatic polycarbonate is 5 to 95:95 to 5.

5. The flame-retardant resin composition of claim 2 wherein the amount of the flame-retardant compound is 1 to 40 parts by weight based on 100 parts by weight of the resin.

6. The flame-retardant resin composition of claim 2 wherein the styrene-based polymer is selected from the group consisting of a styrene-homopolymer, a styrene-copolymer, and a styrene-graft copolymer.

7. The flame-retardant resin composition of claim 6 wherein the styrene-homopolymer is selected from the group consisting of styrene, o-methyl styrene, p-methyl styrene, m-methyl styrene, a -methyl styrene, vinyl styrene, vinyl toluene, halogen-substituted styrene, alkyl ring-substituted styrene, and a polymer obtained from at least one vinyl compound.

8. The flame-retardant resin composition of claim 6 wherein the styrene-copolymer is a copolymer prepared by copolymerizing one or more styrene-based monomers and one or more vinyl-based monomers that are copolymerizable with the styrene-based monomer: the styrene-based monomer being selected from the group consisting of styrene, o-methyl styrene, p-methyl styrene, m-methyl styrene, a -methyl styrene and vinyl toluene: and the vinyl-based monomer being selected from the group consisting of a cyanide vinyl compound, a C₁-C₈ alkylacrylate, a C₁-C₈ alkylmethacrylate, a maleic acid dialkylester, and an N-substituted maleimide.

9. The flame-retardant resin composition of claim 6 wherein the styrene-graft copolymer is a graft copolymer prepared by graft-copolymerizing one or more styrene-based monomers, one or more vinyl-based monomer being copolymerizable with the styrene-based monomers, and a diene-based monomer, the styrene-based monomer being selected from the group consisting of styrene, o-methyl styrene, p-methyl styrene, m-methyl styrene, α-methyl styrene and vinyl toluene;
the vinyl-based monomer being selected from the group consisting of a cyanide vinyl compound, a C₁-C₈ alkylacrylate, a C₁-C₈ alkylmethacrylate, maleic acid dialkylester, and an N-substituted maleimide; and
the diene-based monomer being selected from the group consisting of butadiene, dicyclopentadiene, isoprene, chloroprene, phenylpropadiene, cyclopentadiene, 1,5-norbonadiene, 1,3-cyclohexadiene, 1,4-cyclohexadiene, 1,5-cyclohexadiene and 1,3-cyclooctadiene.

10. The flame-retardant resin composition of claim 2 wherein the phosphoric ester flame-retardant compound has a melting point of 70 to 89° C.
